(19) United States
(12) Patent Application Publication
(10) Pub. No.: US 2012/0072405 A1
(43) Pub. Date: Mar. 22, 2012

(54) SIMULATION-ASSISTED SEARCH

(75) Inventors: Louise Guay, Montreal (CA); Claude Faribault, Montreal (CA); Gregory Saumier-Finch, Montreal (CA); Elizabeth Haydock, Montreal (CA); Jean Francois St. Arnaud, Montreal (CA)

(73) Assignee: My Virtual Model Inc., Montreal (CA)

(21) Appl. No.: 13/047,321

(22) Filed: Mar. 14, 2011

Related U.S. Application Data
(63) Continuation of application No. 11/751,485, filed on May 21, 2007, now abandoned.
(60) Provisional application No. 60/747,758, filed on May 19, 2006.
(60) Provisional application No. 60/804,952, filed on Jun. 16, 2006.

(51) Int. Cl. G06F 17/30

(52) U.S. Cl. 707/706; 707/E17.108

(57) ABSTRACT

A visually-oriented search system guides a search with non-verbal inputs. Instead of specifying discrete attributes (words) as input to a search engine, a user may create a visual model of a desired end result and apply the model as a generalized input from which discrete attributes are extracted for submission to conventional search engines. The search may be enhanced with a simulation of the visually-created query, and the simulation may be transformed into a query suitable for distribution to one or more search engines. The query may be refined using domain-specific rules, vocabulary, expert systems, and the like. Search results may be browsed by a user, or employed to further refine subsequent searches.

### RELATED APPLICATIONS

This application claims the benefit of U.S. App. No. 60/747,758 filed on May 19, 2006 and U.S. App. No. 60/804,952 filed on Jun. 16, 2006. Each of these applications is commonly owned, and each of these applications is incorporated by reference in its entirety.

### BACKGROUND

1. Field

The present invention relates to methods and systems for creating queries for search engines.

2. Background

With the advent of pervasive networked computing, search engines have become increasingly important and increasingly sophisticated tools for locating online content. Advances in search engine technology have expanded the scope of indexed content, increased the speed of searches, added flexibility to the syntax of user queries, and improved the relevance of search results. However, search remains generally tied to the use of textual input, either through the entry of keywords or through menu-driven specification of search parameters. These techniques provide little assistance to users engaged in searches for content with visual features, particularly where users are unfamiliar with the terminology used to describe those visual features.

There remains a need for improved search engines that simplify construction of queries for a user without requiring domain-specific knowledge.

### SUMMARY

A visually-oriented search system guides a search with non-verbal inputs. Instead of specifying discrete attributes (words) as input to a search engine, a user may create a visual model of a desired end result and apply the model as a generalized input from which discrete attributes are extracted for submission to conventional search engines. The search may be enhanced with a simulation of the visually-created query, and the simulation may be transformed into a query suitable for distribution to one or more search engines. The query may be refined using domain-specific rules, vocabulary, expert systems, and the like. Search results may be browsed by a user, or employed to further refine subsequent searches.

### BRIEF DESCRIPTION OF FIGURES

The systems and methods described herein may be understood by reference to the following figures wherein:

FIG. 1 shows a conceptual block diagram of a visually-oriented search;

FIG. 2 shows entities that may participate in a visually-oriented search system;

FIG. 3 shows a user interface for a visually-oriented search system;

FIG. 4 shows a user interface for a visually-oriented search system;

FIG. 5 shows a user interface for a visually-oriented search system;

FIG. 6 shows a user interface for a visually-oriented search system;

FIG. 7 shows a user interface for a visually-oriented search system; and

FIG. 8 shows a high-level flow chart of a process for simulation-assisted search.

### DETAILED DESCRIPTION OF FIGURES

The following methods and systems are described generally in the context of a web-based product search and configuration system. While a number of the following examples focus on clothing, it will be understood that a clothing search system is described by way of illustrative embodiment and not of by way of limitation. The systems and methods described herein may be usefully employed in a wide range of search applications including finding individuals for dating, finding music of a certain style, furnishing a house or apartment, purchasing an automobile, shopping for a house, and so forth. Still more generally, it will be understood that the principles described herein may have significantly broader application, and may be usefully employed in any environment where non-verbal cues and/or simulation may be employed to guide a user to relevant content. As an example, while the user interface described below emphasizes visual search and simulation, non-visual aspects of search may be employed as well, such as by using auditory cues to guide searching for a musical selection or an instrument purchase. All such variations are intended to fall within the scope of the systems described herein.

In one aspect, the systems described herein may assist a user in building a desired model by providing visualization and domain-specific expert systems. The user may adjust the model visually and interactively using visual elements selected from a palette of options displayed within a user interface. This removes or diminishes the need of the user to be a domain expert, or to be familiar with vocabulary used to describe various aspects of an item or type of item. This may be particularly useful where, for example, a user sees a new style of clothing or feature, and would like to search for clothes having that feature without knowing any of popular or trade names for the feature. Once a user has created a satisfactory visual model, which may be simulated visually within the user interface, a set of discrete, searchable, domain-specific attributes may be extracted from the simulation model (or from the visual attribute selections used to create the model). A search can then be performed directly using the extracted search attributes, or a query such as a textual search string may be generated for distribution to various search engines. The search string may also be expanded through the use of domain-specific knowledge as applied, for example, through an expert system. The search may explicitly or implicitly target results tagged with corresponding descriptions or metadata.

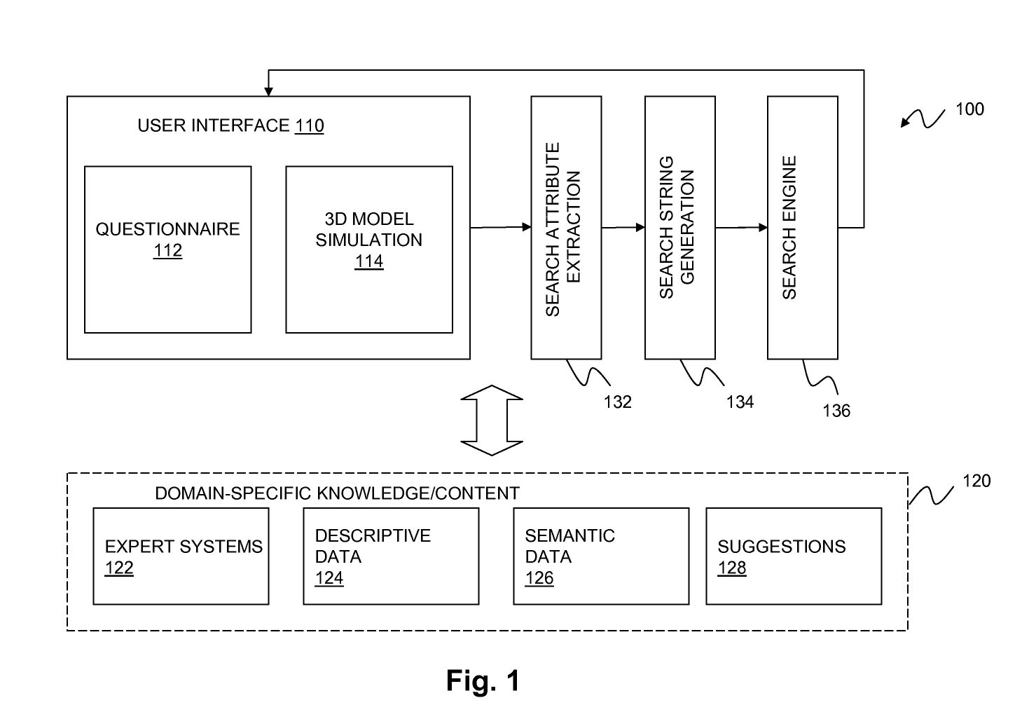

FIG. 1 shows a conceptual block diagram of a visually-oriented search. The system 100 may include a user interface 110 that provides a questionnaire 112 and a three-dimensional model simulation 114 that applies results of the questionnaire. The system 100 may provide processing for search attribute extraction 132, search string generation 134, and a search engine 136. In addition, domain-specific knowledge 120 may be deployed generally through the system to support various search functions. The domain-specific knowledge 120 may be implemented, for example, as rules and expert systems 122, a database of suitable three-dimensional sub-entities 124, semantic data 126 such as synonyms, word mappings, exclusions, and so forth.

The user interface 110 may be, for example, any computer user interface suitable for presentation on a client device such as a personal computer, laptop computer, cellular phone, personal digital assistant, public kiosk, and so forth. The user interface 110 may employ Web technologies such as HTML, Java, JavaScript, J2ME, J2SE, J2EE, Flash Media, AJAX, and any other technologies for local and/or remote processing and presentation of a user interface, as well as any proprietary technology suitable for use with the systems described herein.

The questionnaire 112 generally operates to receive user input concerning visual attributes. The following description periodically refers to visual attributes as types that, together with specific values, form attribute-value pairs (such as a visual attribute of “color” with a value of “red”). However, a visual attribute may also or instead be understood as a type and a value that together serve as an attribute-value pair to describe some visual aspect of a physical object such as an article of clothing. Further, certain values may weakly or strongly imply a particular attribute type (such as “high heel” suggesting a heel type) such as to render an explicit attribute type unnecessary. In the following description, all such meanings are intended to fall within the scope of the term “visual attribute,” unless a more specific meaning is provided or otherwise clear from the context.

The questionnaire 112 may present a menu of selections to a user within the user interface 110. This may include checkboxes, radio buttons, drop-down lists, or any other controls for receiving user input. Where visual features are being selected, such as a car shape (e.g., sedan, wagon, coupe, SUV, and so forth), a user may be presented with abstract graphical representations of the various features from which to select the desired feature. Other visual aspects may be amenable to different input means, such as sliders to select various bodily dimensions on a graphically displayed mannequin, or a continuous color palette from which to interactively select color. While any features, attributes, or other information may be specified in the questionnaire 112, three general areas of information are described below.

The questionnaire 112 may acquire personal information. For example, the system 100 may be applied to specify clothing, in which case, relevant personal information may include body type, body dimensions, body shape, height, weight, skin tone, gender, hair color, hair length, hair style, face shape, head shape, facial hair, muscularity, and so forth. As noted below, personal information may be employed to create a personalized simulation or virtual model upon which clothing selections can be simulated. As another example, the system 100 may be applied to select appliances for a kitchen. In this case, personalization information may include an existing kitchen layout, furnishings, flooring, cabinetry, countertops, and so forth, all of which may be used to create a personalized model kitchen in which appliance selections can be simulated.

The questionnaire 112 may acquire visual attributes of a product. In order to assist a user in selecting suitable visual attributes, a number of possible selections may be presented to the user. For example, for footwear this may include laces, soles, heels, materials, straps, toes, and so forth. The questionnaire 112 may also provide high-level guidance, such as by initially requesting a shoe type (e.g., athletic, formal, casual, outdoor), which may be further refined within a sub-type (e.g., for formal footwear, categories for men's and women's shoes, or professional and evening wear) to pre-parameterize visual features. This pre-parameterization may limit the availability of visual attribute selections according to current fashion. For example, it may be highly unusual to find a woman's high-heeled formal shoe with Velcro straps, or a men's running shoe with high heels. These limitations may be strictly enforced, or may be flexibly enforced in the form of recommendations. Visual attributes may be specified in a variety of ways within the questionnaire. For example, color may be specified in textual form by a user text entry, by selecting a color from a list of options, or by selecting a color or range of colors from a color palette. Using the techniques described below, the user's color selection may be translated into one or more keywords corresponding to conventional names, trade names, and/or vendor names for various colors and color schemes.

The questionnaire may also acquire non-visual attributes of a product. For example, in an automobile search, non-visual attributes such as engine type, miles per gallon, and so forth may be relevant for a user. Values for these attributes may be specified through the questionnaire, and used as a basis for search in addition to visually specified information. It will also be appreciated that some information may be considered visual or non-visual. For example, shirt size may be assumed to be non-visual information if it is assumed that a range of sizes will be available for any product. On the other hand, shirt size may be a highly relevant visual attribute if a user is selecting between relatively loose-fitting or tight-fitting clothing and would like to receive visual simulation of size alternatives.

The three-dimensional model simulation 114 may visually display a simulation of an object along with user-specified visual attributes and/or any personalization data provided in the questionnaire 112. The simulation may be incrementally updated as a user makes selections within the questionnaire. The simulation may be, for example, a three-dimensional simulation (typically, though not necessarily rendered in two dimensions for display on a conventional computer display or the like), a two-dimensional simulation, an animated simulation, an auditory simulation, a mechanical simulation, a lighting simulation, or any other still or time-based simulation, as well as various combinations of any of the foregoing. In addition to the attribute-value pairs for visual features of an object, a user may specify various simulation-specific aspects for the generation and display of the simulation. For example, for an animated, three-dimensional, personalized simulation of an article of clothing on a body, a user may select a motion type for the simulation such as standing, walking, running, sitting, and so forth. For simulations of objects, a user may specify a point of view, lighting, and so forth.

In addition, it will be understood that a simulation may include any number of simulated physical objects. For example, where a user is selecting articles of clothing, a number of clothing items may be concurrently simulated, such as a shirt and a pair of pants. In addition, other items such as accessories, other apparel, and the like may be included in a single simulation. Again using the clothing simulation as an example, a user may select socks, shoes, hats, handbags, knapsacks, belts, scarves, sunglasses, jewelry, and so forth.

In one aspect, the simulation may be supplemented with search results from the search engine 136. For example, manufacturers or retailers may maintain simulation-compliant data for products. Where this data is available, search results may be displayed in the user interface 110, and simulation-compliant results may be identified with an icon or the like in the search results. A user may select the icon to transfer the attributes of the search result directly to the simulation. Thus, the systems and methods described herein may be enhanced by adding simulation-compliant attributes to content retrieved by the search engine. These attributes may be added, for example, by retailers who are offering items for sale, or their corresponding wholesalers or manufacturers. The attributes may also, or instead be created automatically through computerized examination of information that is available for such products.

It should be understood that, while a two-dimensional rendering of a three-dimensional simulation 114 is illustrated in the following figures, other forms of simulation may be suitably employed. For example, the simulation may provide a two-dimensional simulation such as an architectural floor plan or an industrial layout where component footprint (as well as any required buffer space surrounding components) is important. Similarly, art layouts, vertical shelf space, or any other design or purchase decisions driven by substantially two-dimensional constraints can be usefully simulated in two-dimensions. Similarly, non-spatial simulations may also be employed, such as auditory or tactile simulations that permit sensory simulation corresponding to some feature of the subject matter of a search. All such variations are intended to fall within the scope of this disclosure.

A search attribute extraction module 132 may extract attributes from the simulation for searching. In one aspect, this may include an analysis of explicit user selections such as the visual attributes selected in the questionnaire 112. In another aspect, this may include visual analysis of the simulation result.

A search string generation module 134 may convert the attributes into a search string suitable for presentation to a remote search engine 134. This may include converting the search attributes into a suitable syntax for submission to one or more search engines. The search engine may be any network-accessible search engine including wide scale public search engines such as Google, Yahoo, AltaVista, and the like. The search engine may also, or instead, include specialty search engines at retail sites hosted by general retailers or branded product companies. The search engine may also, or instead, include auction web sites, product selection sites, product configuration sites, product review sites, or any other electronic commerce site or other web site that responds to search requests. The search engine may also or instead include local search engine created for use with the search systems described herein. The search engine may employ any suitable algorithms known in the art including textual search algorithms such as proximity searching, string matching, word stem searching, fuzzy logic, and so forth. A search engine may also, or instead, employ spatial searching based upon the simulation model using, e.g., feature vectors, neural networks, skeletal graph techniques, and so forth.

As a significant advantage, a computer-generated search string may take full advantage of the query syntax of each search engine addressed, to the extent that features of the syntax are known. For example, different search engines provide different grammars and features relating to wild cards, word stems, word variants, Boolean operators, proximity searching, synonyms, exclusions, and so forth. While a human user would typically not know how to optimize a query for any particular search engine, the computer-generated search strings may be tailored to the features and syntax of each search engine.

Domain-specific knowledge and content 120, also referred to herein as a knowledge base 120, may be used throughout the system described above. For example, domain-specific knowledge may be employed in forming a questionnaire for a particular subject matter area, for generating simulations, for extracting search attributes from a simulation, generating search strings, and selecting suitable search engines. One useful form of domain-specific knowledge for some applications is a dictionary or taxonomy of keywords for visual attributes. Other domain-specific knowledge may relate to relationships among visual attributes. This may be implemented by ranking choices in the questionnaire 112 where, for example, certain cuffs and collars are usually but not exclusively used together for clothing. This may also be implemented by removing certain choices from the questionnaire 112 where, for example, a selection of one value for a visual attribute necessarily excludes other visual attributes (e.g., a cuff style for a skirt). Some examples of domain-specific knowledge that may be usefully employed with the systems described herein are set out below.

The system may employ a rules engine and/or expert systems 122, referred to herein interchangeably unless a more specific meaning is specifically provided or otherwise clear from the context. In general, an expert system incorporates subject- specific knowledge or analytical skills from human experts, which may be implemented as a set of rules for analyzing and acting on inputs. The rules engine may provide known expert system functionality using, for example Prolog to parse rules and maintain an associated knowledge base. The rules may be based on context, such as personalization information provided above, and existing entities/sub-entities within the context, along with current selections of values for visual attributes, placement, configuration, and so forth. While rules are one useful basis for deploying expert systems, other techniques may also or instead be employed such as neural networks, artificial intelligence, heuristics, fuzzy logic, machine learning, and the like, all of which may be similarly adapted to operate according to human-derived expertise. In one aspect, the context may define available sources for items, so that, for example, a kitchen outfitted with items from one retailer (e.g., Home Depot) may be compared to the same kitchen outfitted with items from a competing retailer (e.g., Loews). It will be noted that the systems and methods described herein may also support a simulation-based product comparison that visually simulates two or more products for visual comparison while providing a detailed comparison of other objective criteria such as price, delivery time, and so forth.

The knowledge base 120 may generally establish descriptive data 124 for entities and sub-entities known within the system, and store associated attributes of each sub-entity and relationships among sub-entities. For a clothing example, this may include physical object types (e.g., shirt, pants, dress), visual attributes (e.g., collar, sleeves, hemline), and values for visual attributes (e.g., for a collar, the values may include v-neck, crew neck, polo, etc.). More generally, it will be understood that a physical object may be described with reference to one or more visual attributes, each of which may have a variety of values, and that this taxonomy of properties may be represented in the descriptive data 124 of the knowledge base 120. Other descriptive information may also be provided such as prices, price ranges, sizes, availability, and so forth. Other information, such as context, personalization, and the like, may be used in combination with descriptive data 124 in the knowledge base 120 to guide a user selection process based upon, for example, current selections, dependencies among items, incompatibilities (which may include the selected item), set dependencies (related items), and so forth.

Semantic data 126 may be provided for construction of more thorough search strings. In general, semantic data 126 may encode semantic content to augment or constrain search parameters extracted from the simulation. For example, a dictionary, thesaurus, or the like may be employed to identify related or similar terms for searching. This may be based upon domain-specific knowledge for a search, or more narrowly upon search keywords. Similarly, exclusions may be provided to remove search parameters, or to restrict searching to relevant subject matter. For example, a search for a collar in the context of clothing should exclude animal collars and option collars. In another aspect, semantic data 126 may conform to any available standards for describing terms and relationships for network content. For example, the “semantic web” refers broadly to a philosophy, design principles, and a variety of enabling technologies for describing content in a manner amenable to use and interpretation by software agents. Existing formal specifications for the semantic web include (among others) the Resource Description Framework (“RDF”), the RDF Schema, and the Web Ontology Language, all of which seek to formally describe terms and relationships within a knowledge domain. By incorporating any or all of these descriptions into the semantic data 126, the system may more readily integrate with other semantically-oriented systems including semantic search engines on one hand and semantic product information sources (such as semantic labeling systems used by manufacturers) on the other.

In one aspect, tools may be provided to vendors or other sources of product information to permit labeling consistent with semantic web principles. A tool may, for example, provide a predetermined ontology for product description. This may guide a vendor's selection of visual attribute types and values within a hierarchy of existing terms/concepts for a product. By tagging products with concepts and terminology from the existing ontology, new content may be released with metadata that is pre-configured for efficient use with a visually-assisted search system. Thus the product may be released for use with the search system, or any other semantic-web-compliant systems, simply by publishing a product image and the associated metadata to a network-accessible location. In order to further enhance a vendor's use of the simulation-assisted search system, tools may be provided for preparing a simulation-compliant model of the product in the form of a software developer kit, web-based application programming interface, or the like. The details of such a system will necessarily depend on the particular product, simulation system, and other technical details. However, preparing a distributable version of a simulation software development tool kit (or a web-based application programming interface) is well within the level or ordinary skill in the relevant programming arts, and is intended to fall within the scope of the systems and methods described herein.

In order to facilitate use with visually-assisted and/or simulation-assisted search, network content may be tagged with descriptive metadata corresponding to, for example, a product name, a product type or class, product description(s), product visual attributes, and so forth that might be responsive to a search. Tags may include information such as make, model, color, price, finish, materials, part numbers or sku's, sizes, features, characteristics, and narrative descriptions. Within a domain, tags may be more specifically tailored to content so that, for example, clothing may have readily discernible descriptive tags for visual attributes such as fabric, color, size, sleeve type, neckline type, and so forth. Other information that might be relevant to a purchasing decision may also be included such as brand, year of make, store location, care instructions, and retailer. In addition, semantically-oriented tags may be provided to capture subjective features such as style, item popularity, and so forth.

In one aspect, retailers may coordinate with the search system 100 so that a common vocabulary is provided for searching, and the retailer may be provided with a tagging tool as generally described above. The tagging tool may assist in correctly tagging inventory with attribute values that correspond to searches developed using the visually-assisted and/or simulation assisted search systems described herein.

The source of tags may be important, and the system may provide for a tagging structure that recognizes tag source as a parameter for searching and displaying results. For example, a manufacturer may explicitly tag products with metadata including product names and the like that uniquely identify the manufacturer's products. The manufacturer may also provide descriptive content. This tagging may or may not be perceived as reliable by consumers, but the descriptive tags from a manufacturer may be clearly identified so that a user can independently determine what weight to afford these manufacturer-derived descriptions. Retailers may also separately tag products, again subject to various user interpretations of reliability. Objective reviewers may be afforded a different tagging hierarchy, so that metadata from reviews by various individuals or institutions can be separately considered. A variety of techniques are known in the art for reliably determining content source, such as digitally-signed certificates, that may be usefully employed with the systems described herein to support separate handling of source-sensitive tags and other metadata. In another aspect, tagging may be controlled or supported by a trusted third party so that the source of tags can be verified or otherwise examined for authenticity with reference to an external authority. In a certificate-based authentication model, a commercial trusted third party such as VeriSign, Entrust or the like may be used to manage certificates. Tags may also or instead be community-based, such as through social networking sites that permit ad hoc tagging of content. While posing potential reliability problems, this source of metadata may be uniquely suited to identifying popular visual attributes, or identifying new descriptive terms appearing in popular culture. Community-based or other consumer-level tagging may accommodate a wide array of annotations including rankings, photographs, descriptions, comments, evaluations, and so forth.

Some or all of these tag sources may be combined to provide a search system in which tags are identified according to source. The sources may be categorized and/or weighted according to source, tag content, and any other suitable criteria, with the hierarchical arrangement applied by a search engine to weight or rank search results. For example, tags from a manufacturer may be afforded a highest priority. This prioritization is based upon an assumption that a manufacturer directly specified the tags for a desired association, based upon a specific product name, stock keeping unit, product code, or the like. Another level, such as a second highest priority, may be accorded to search results with tags that closely or exactly match the search string extracted from the model. Another level may be provided for tags created by a qualified organization such as a retailer. These tags may carry a presumption of reliability, although not tied specifically to a product manufacturer. Another level or weight may be accorded to search results with tags that loosely match the search string based upon, e.g., keywords, synonyms, and the like. Another level or weight may be accorded to tags created by individual consumers or social networking sites. Another level or weight may be accorded to other content, such as images matching the simulation model based on pattern recognition.

A suggestion or recommendation engine 128 may be provided that generates recommendations based upon information in the knowledge base 120. For example, the recommendation engine may suggest items that go well together, additional features suitable for a context (e.g., if you select an oven, you may need a hood, or you may need to remove overhead cabinets, and perhaps a microwave could suitably be added, or moved from another location). The recommendation engine 128 may also or instead identify related items based upon purchase history for other users. Numerous other suggestion and recommendation techniques are known in the art and may be suitably incorporated into the knowledge base 120 of the system 100 described herein.

It will be understood that the search systems and supporting components (such as domain-specific knowledge and content) may be implemented in computer executable code that supports operation of a web server to provide a web-based client-server deployment of the system 100 described herein. Other deployments include, for example, a web application, a closed in-store system for use at a physical retail location, an application programming interface (or collection of API's) for use in third-party web application integration, one or more services for use in a services-oriented architecture, and so forth. All such permutations are intended to fall within the scope of this disclosure. In general, systems described above may be local or distributed, or some combination of these. For example, the domain-specific content 120 or portions thereof may be locally deployed on a client device, or may be stored at a remote, network-accessible location for use by a server or client. Other features, such as the questionnaire, the simulation, the search attribute extraction, and so forth, may similarly be deployed locally at a client, or remotely accessed for use in the systems described herein. In general, the search engine(s) 136 would be remote from the client, particularly in applications intended for use with third party search engines, however, this is not strictly required, and in some embodiments the search engine, or portions thereof, may reside locally at a client device that provides the user interface 110. For example, where a retailer provides an in-store product selector using visually-oriented search and simulation, the entire domain-specific knowledge base, search engine, simulation, and user interface may be deployed on a single stand-alone device (or a device that is networked to receive updates and the like).

Other systems and methods may be used to enhance the general architecture described above including without limitation variations to components of the system 100 and additional sub-systems that may cooperate with or be integrated into the components described above. A number of enhancements are now described in greater detail.

The systems described herein may be improved by providing keyword suggestion to a user, such as through suggestions 128 to the questionnaire 112 or a separate window or pop-up within the user interface 110. This may, for example, suggest keywords that appear applicable to a user's search such as neighboring concepts or synonyms, based upon domain-specific knowledge 120 within the system 100, or based upon an analysis of tags obtained from a social networking site. A user may then optionally review keywords and explicitly select or exclude particular keywords based upon the user's desired results and understanding of the keywords presented. In one aspect, the system may dynamically provide an estimate or actual measure of the number of results in a search result set based upon the user's selections. This may permit a user to adjust the scope of a search according to a desired number of results. More generally, the system may analyze the current search attributes, the current simulation, and any potential search strings derived therefrom to recommend additional parameters for a user. For example, applying domain-specific knowledge, a search for shirts may generate keywords and queries for neighboring concepts such as blouses and tees. These results may be incorporated into a search, or presented to a user for explicit selection of relevant items.

Thus, a product-oriented search may be improved using the systems described above, both by providing a visual interface for individuals who might be unfamiliar with terminology in the field of a product and by providing detailed control over the structure of a search for users more familiar with a content domain. In either case, the system may apply expert, domain-based knowledge either to formulate actual queries or refine explicitly specified user queries.

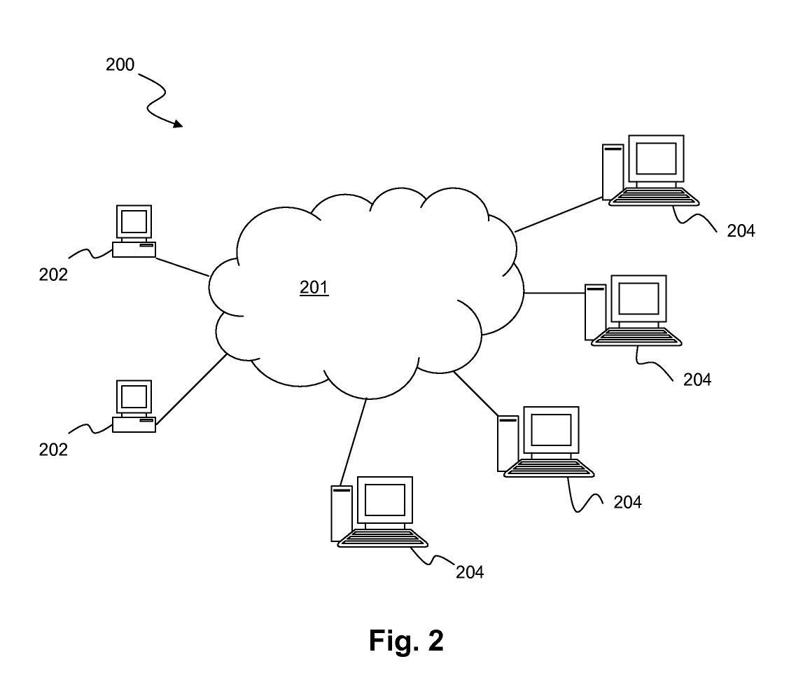

FIG. 2 shows entities that may participate in a visually-oriented search system. The system 200 may include a network 201 interconnecting a client 202 and a number of servers 204-210.

The network 201 may interconnect a plurality of clients 202 and servers 204-210. In general, any number of clients 202 and servers 204-210 may participate in such a system 200. The system may further include one or more local area networks (“LAN”) interconnecting clients 202 through a hub (in, for example, a peer network such as a wired or wireless Ethernet network) or a local area network server (in, for example, a client-server network). The LAN may be connected to the network 201 through a gateway that provides security to the LAN and ensures operating compatibility between the LAN and the network 201. Any data network may be used as the network 201. In one embodiment, the network 201 is the Internet, and the World Wide Web provides a system for interconnecting clients 202 and servers 204-210 in a communicating relationship. The network 201 may also, or instead, include a cable network (where at least one of the clients 202 would be a set-top box, cable-ready game console, or the like). The network 201 may include other networks, such as satellite networks, the Public Switched Telephone Network, WiFi networks, WiMax networks, cellular networks, and any other public, private, and/or dedicated networks that might be used to interconnect devices for transfer of data.

An exemplary client 202 includes a processor, a memory (e.g. RAM), a bus which couples the processor and the memory, a mass storage device (e.g. a magnetic hard disk or an optical storage disk) coupled to the processor and the memory through an I/O controller, and a network interface coupled to the processor and the memory, such as a modem, digital subscriber line (“DSL”) card, cable modem, network interface card, wireless network card, or other interface device capable of wired, fiber optic, or wireless data communications. One example of such a client 202 is a personal computer equipped with an operating system such as Microsoft Windows XP, UNIX, Linux, or Apple Computer's OS X, along with software support for Internet communication protocols. The computer may also include a browser program, such as Microsoft Internet Explorer, Netscape Navigator, or FireFox, to provide a user interface for access to the network 201. Although a personal computer is one possible client 202, the client 202 may also or instead include a workstation, a mobile computer, a Web phone, a VOIP device, a television set-top box, an interactive kiosk, a personal digital assistant, a wireless electronic mail device, or any other device capable of communicating over the Internet. As used herein, the term “client” is intended to refer to any of the above-described clients 202 or any other client devices suitable for use with the systems described herein, and the term “browser” is intended to refer to any of the above browser programs or other software or firmware supporting a user interface for navigating a network such as the Internet.

An exemplary server 204 includes a processor, a memory (e.g. RAM), a bus which couples the processor and the memory, a mass storage device (e.g. a magnetic or optical disk) coupled to the processor and the memory through an I/O controller, and a network interface coupled to the processor and the memory. Servers may be clustered together to handle more client traffic and may include separate servers for different functions such as a database server, an application server, and a Web presentation server. Such servers may further include one or more mass storage devices such as a disk farm or a redundant array of independent disk (“RAID”) system for additional storage and data integrity. Read-only devices, such as compact disk drives and digital versatile disk drives, may also be connected to the servers. Suitable servers and mass storage devices are manufactured by, for example, Compaq, IBM, and Sun Microsystems. Generally, a server 204 may operate as a source of content or services and may provide any associated back-end processing while a client 202 is a consumer of content and services provided by the server 204. However, it should be appreciated that many of the devices described above may be configured to respond to remote requests, thus operating as a server, and the devices described as servers 204 may operate as clients of remote data sources and services. In some networks such as contemporary peer-to-peer networks and environments, the distinction between clients and servers may blur. For example, certain peer-sharing technologies employ “servelets” that act as both clients and servers within a peer-to-peer network. Accordingly, the term “server” as used herein is generally intended to refer to any of the above-described servers 204, or any other device that may be used to provide content or services in a networked environment.

In the systems described herein, the servers 204 may perform a variety of functions. For example, one or more of the servers 204 may provide the knowledge base and expert systems described above to support visually-oriented search. These servers 204 may be accessed by a client 202 during the search process in order to provide questionnaires, simulation, attribute extraction, search string formation, and so forth. In another aspect, one or more of the servers 204 may provide search engines including any of the wide area or dedicated search engines described herein. In another aspect, one or more of the servers 204 may provide content, such as product listings and information from manufacturers. In another aspect, one or more of the servers 204 may provide transaction engines for financial transactions such as a product purchase. In another aspect, one or more of the servers 204 may provide a bulletin board, on-line classified listings, on-line auctions, or any other services that might generate products potentially responsive to a search. In another aspect, one or more of the servers 204 may provide social networking services such as chat rooms, personalized web pages, discussion groups, web logs, and so forth that might generate relevant metadata for the systems described herein. In one aspect, all of these services may be combined within the user interface of a client 202 to provide an end-to-end search, configuration, and purchase experience.

A number of examples of user interfaces that may be used to perform a search and review search results are now provided. It will be understood that while no specific interface technology is discussed in the following description, a number of suitable technologies exist for various platforms and devices, any of which may be used for presenting the following user interfaces on an appropriately capable client device including client-side applets, JavaScript (client or server), Java on a client-side Java Virtual Machine, browser plug-ins, AJAX, HTML, J2ME, J2SE, J2EE, Flash Media, Web Services, graphics, audio media, video media, streaming media, and so forth. In addition, various aspects of these interfaces may employ client-side technology, server-side technology, or some combination of these. All such variations suitable for use with the interfaces discussed herein are intended to fall within the scope of this disclosure.

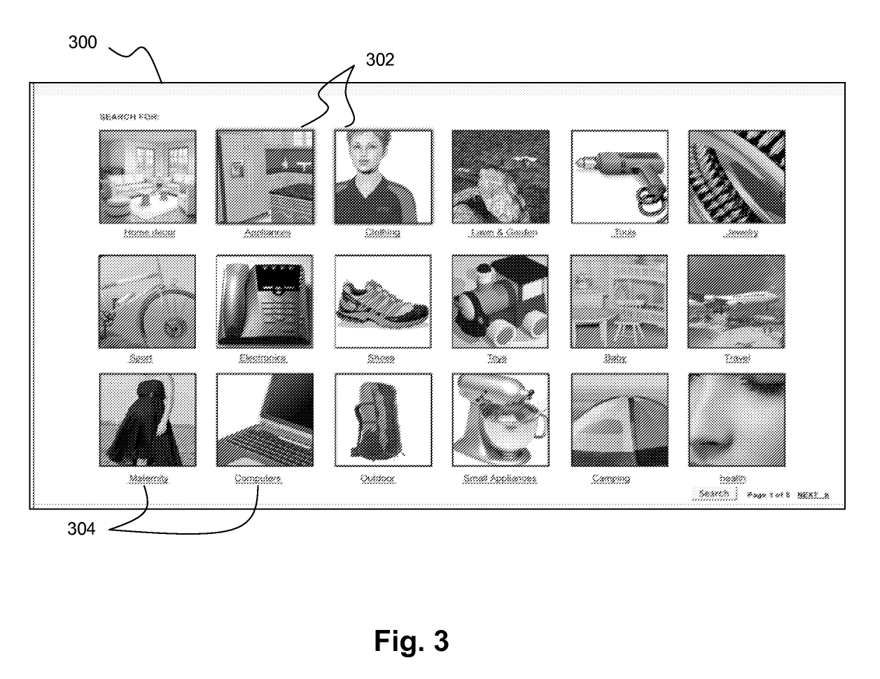

FIG. 3 shows a user interface 300 for a visually-oriented search system. The interface 300 may include icons 302, text hyperlinks 304, buttons, or the like for receiving user input. In this interface, a user may select a general subject matter area, topic, product area, or specific object type for further refinement. By initially limiting a search to a product category or the like, the relevant expert systems and domain-specific knowledge may be selected to guide further user input. As depicted, possible product categories include home decor, appliances, clothing, lawn & garden, tools, jewelry, sport, electronics, shoes, toys, baby, travel, maternity, computers, outdoor, small appliances, camping, and health. Of course, other subject matter areas may usefully be displayed for selection/refinement including the topics generally described herein. In addition, the topic selection process may be hierarchical. That is, a top level selection menu may cover, for example, goods, services, and media, or some other set of high-level categories. In other embodiments, a flat scheme may be preferred so that users are not required to traverse a hierarchy of descriptive categories in order to arrive at an appropriate search domain.

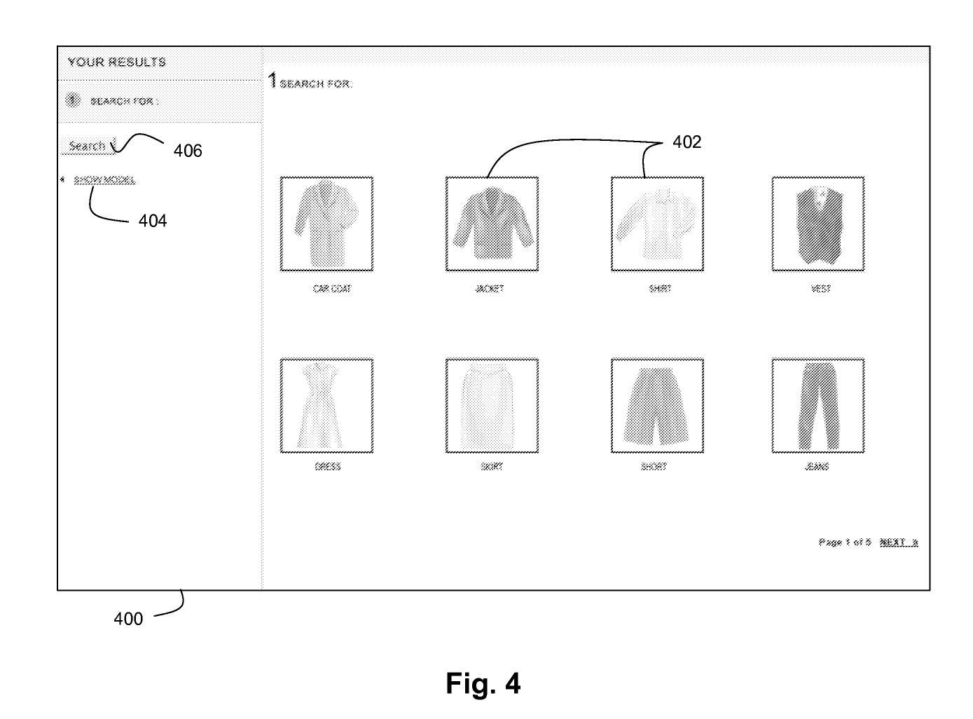

FIG. 4 shows a user interface 400 for a visually-oriented search system. As shown in FIG. 4, once a particular category is chosen, the interface may proceed to present sub-entities 402 within the category. Selections may be received using any suitable user interface tool, including icons, text hyperlinks, text input fields, drop-down lists, check boxes, and so forth. Again referring specifically to the non-limiting example of the figures, a selection of clothing may present clothing types such as car coat, jacket, shirt, vest, dress, skirt, short, jeans, and so forth. The interface 400 may also include a control 404 to activate a simulation model and/or a control 406 to perform a search using the specified visual attributes.

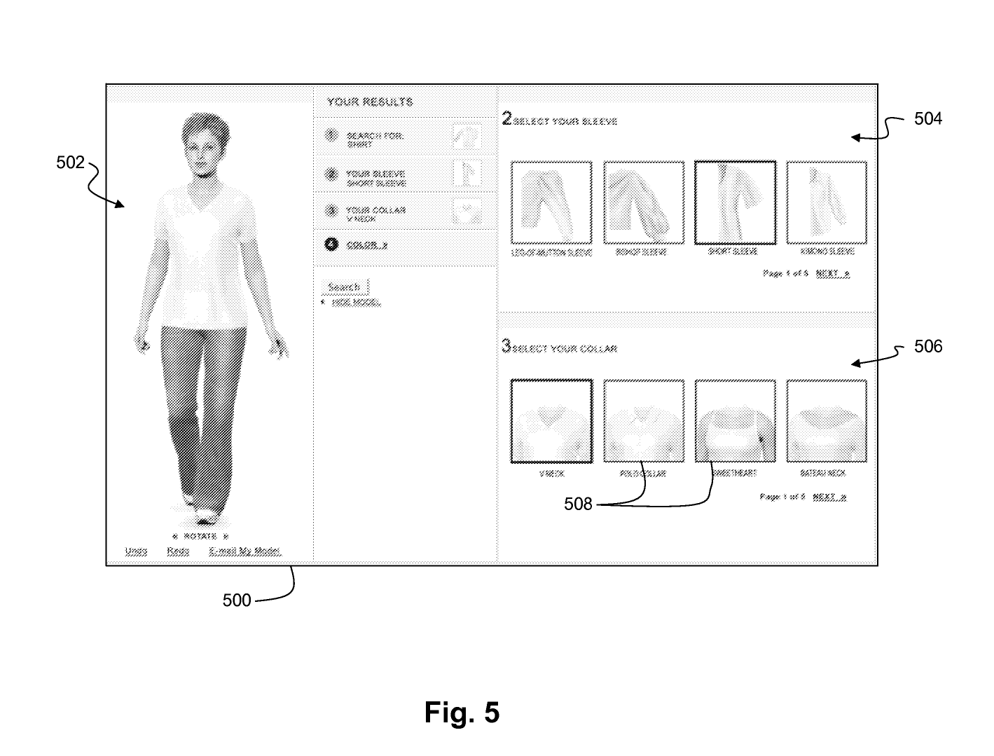

FIG. 5 shows a user interface 500 for a visually-oriented search system. As shown in FIG. 5, once a clothing type is selected, a simulation 502 may be initiated and rendered within a window of the interface 500 for the selected type. It will be understood that this example is non-limiting, and that the simulation may be initiated at an earlier or later point in the search process. The simulation may be personalized, such as by incorporating details of the individual for whom the clothing is being selected. This may include body measurements, hair color, gender, and any other aspects of appearance. The simulation may be interactive, so that a user can alter orientation, lighting, and so forth for the simulation model. In addition, the simulation may be animated so that, for example, the simulation displays the object (in this case, a person) in motion. This may include pre-defined or user-defined motions such as standing, sitting, walking, running, and so forth.

The user interface may also present a number of visual attributes such as a sleeve type 504 and a collar type 506. Each attribute may have a number of possible values 508 represented by drawings, keywords, and the like. For convenience, a subset of possible values 508 may be initially depicted. FIG. 5 illustrates the selection of various visual features of the selected clothing type. In this case, a number of sleeve types are presented, including a leg-of-mutton sleeve, a bishop sleeve, a short sleeve, and a kimono sleeve. A number of collar types are also presented, including a v neck, a polo collar, a sweetheart top, and a bateau neck. As with other selectable visual attributes described herein, a “next” option or other user control to may be provided to control viewing of more or additional options.

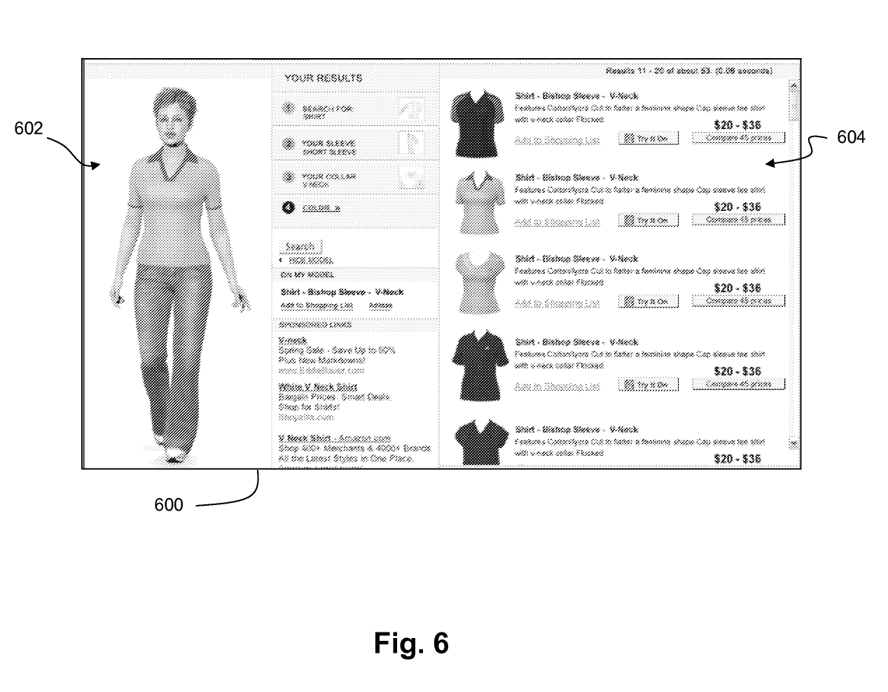

FIG. 6 shows a user interface 600 for a visually-oriented search system. As shown in FIG. 6, a number of visual attributes for clothing have been selected and refined to specify particular values. Search results for this selection, using attributes extracted from the simulation 602 (or the selection process used to produce the simulation) may then be presented in a search result window 604. The display of search results may include, for example, price information, visually descriptive information, product images, and so forth. Where a particular search result is simulation-compliant, a user may select the product for incorporation into the simulation 602 using a “try it on” or other appropriate control. Thus, a user may apply one or more search results to the personalized model in the simulation 602 for a virtual fitting of the product.

Other features may suitably be incorporated into the interface described herein. For example, the interface may support purchase transactions using any suitable techniques known in the art. This may include a shopping cart or the like for gathering multiple items into a single purchase. In another aspect, a user may save a current product and any related visual attributes (or other attributes) to serve as a basis for additional searches. Thus, for example, a user may identify an item of interest, and use this item as a basis to search for similar items either immediately or at some future time.

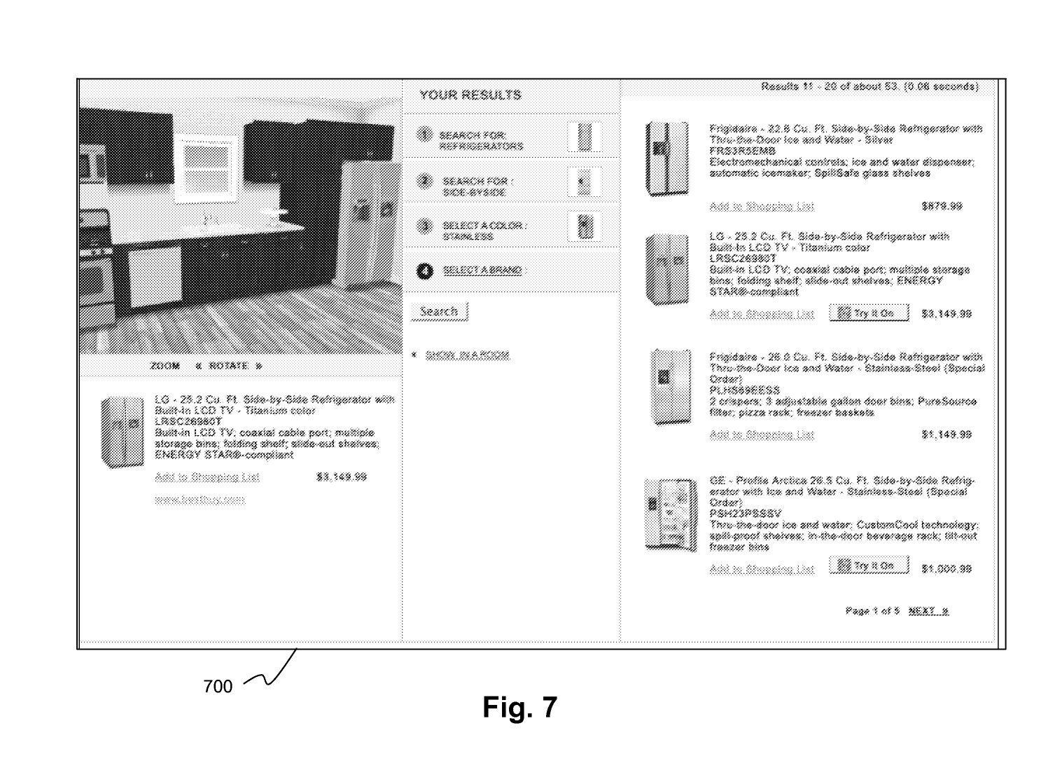

FIG. 7 shows a user interface 700 for a visually-oriented search system. This interface 700 shows another embodiment of the systems described herein as applied in a different context—home furnishing. In this case, a user may specify appliances and various aspects of appliances, and these selections may then be simulated within a personalized model of a user's kitchen. More generally, any room of a home may be simulated, and furnishings such as furniture, paint, carpeting, appliances, flooring, tiles, windows, and so on, may be incorporated into the simulation to aid in visual selection of desired products.

According to the foregoing, there is generally described herein a user interface for visually assisted searching that includes a first window that receives an incremental specification of a plurality of visual attributes for a product from a user to provide a specification for the product. A second window may display a simulation of the product according to the specification, and a control such as a button may initiate a search among a plurality of remote search engines for items having the plurality of visual attributes. A third window may display search results from the plurality of remote search engines. As described above, a questionnaire or the like may be used to gather user information and the user interface or related software may translate the user-specified simulation into queries for remote search engines.

According to the foregoing, there is also disclosed herein a method, and a computer program product embodying the method, for visually-assisted and/or simulation-assisted searching. An example embodiment of this method is now described in greater detail.

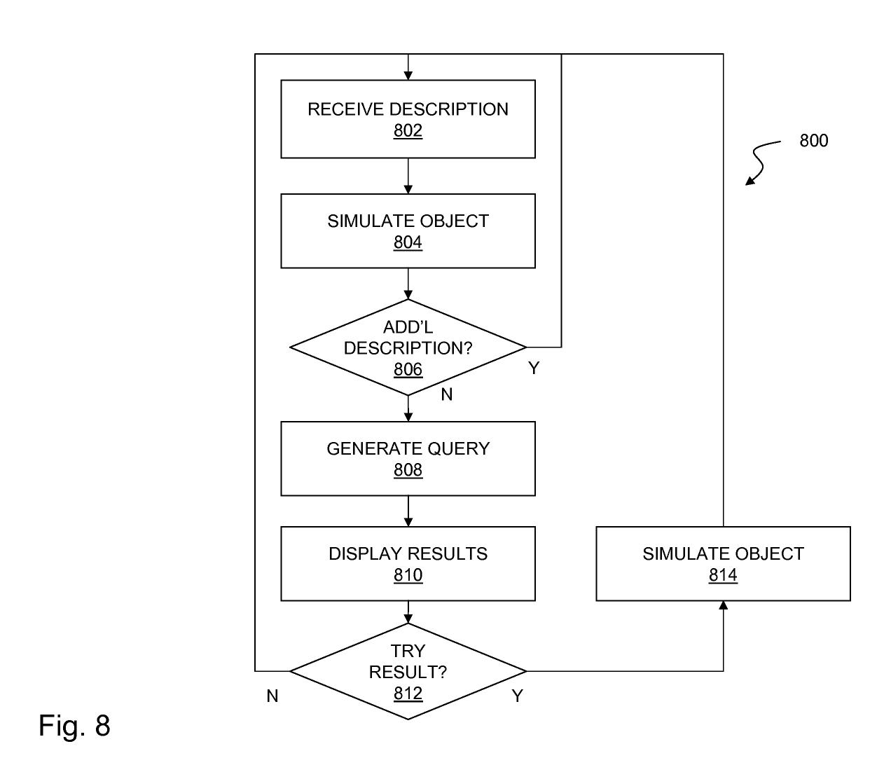

FIG. 8 shows a high-level flow chart of a process 800 for simulation-assisted search. It will be understood that the systems described above include a user interface with numerous windows, each of which may be in various states for displaying and/or receiving information, any of which may depend on user inputs and the states of other ones of the windows. Thus FIG. 8 illustrates only one possible, representative series of steps as an example process incorporating many of the features described above, and should not be understood as limiting the systems and methods described herein.

The process 800 may begin with receiving a description of a product as shown in step 802. This may include, for example, input received from a textual questionnaire, a visually-based questionnaire, or any of the other techniques noted above. The questions may be directed at locating responsive items, such as by identifying size, color, shape, ornamentation, and the like. Within a particular domain, various visual features may be presented and selected. For example, when searching for a shirt, a user may select from various lengths, materials, sizes, cuts, sleeve types, collar types, colors, buttons and/or laces, and so forth. The responses may be captured as a number of visual attributes for an object, which may be represented as attribute-value pairs as described above.

Other information may also be gathered as described above. The questions may also or instead be directed at personalizing search results. For example, in a clothing example, a user may provide information such as body shape, measurements, height, weight, shoe size, and so forth. In a home furnishing example, a user may provide information such as room dimensions, current appliances, window locations, floor type, and so on. This personalization information may be employed to provide context for search results, and to control the simulation as rendered for the user.

As shown in step 804, the process 800 may generate a simulation, such as any of the simulations described above, of the object as specified by the user, which may be displayed in any suitable manner within a user interface or the like. This may include a three-dimensional simulation such as a human model wearing clothing specified by the inputs or a room of a house furnished according to user selections. The simulation may be based on personalization data and visual description data provided by the user, in combination with a library of pre-existing three-dimensional sub-entities and entities. An expert system may apply domain-specific knowledge, such as dressing rules for clothing to conform user inputs to existing clothing styles, fashions, and features. The simulation may account for surface textures, finishes, materials, lighting, and so forth. The simulation may be animated, such as by simulating a person walking while wearing user-selected clothing. The simulation may be rendered within a user interface for viewing by a user.

As shown in step 806, additional description may be considered. Upon viewing the simulation, a user may adjust model parameters in an iterative fashion (e.g., by repeating the steps above). If additional description is desired, the process 800 may return to step 802 where additional description is received. The user may incrementally describe an object in this fashion until a satisfactory model is derived for use in searching.

When no additional description is required, the process 800 may proceed to step 808 where a search engine query is generated. While certain description herein refers to extraction of visual attributes from a simulation, it will be understood that this extraction may take a number of forms. For example, the extraction of visual attributes from a simulation may be based upon an analysis of attribute selections used to create the simulation, data associated with the simulation, or direct graphical inspection of the simulation, or some combination of these. The translation from a user-specified simulation to a textual query may employ any or all of the techniques outlined above including without limitation an application of domain-specific knowledge that might be derived from expert systems, dictionaries, thesauruses, semantic analysis, object definitions, and so forth. However obtained, the process 800 may arrive at a search query suitable for presentation to one or more search engines. Where multiple search engines are used, a number of corresponding queries may be devised according to search engine syntax and any constraints or enhanced features provided therein. As noted above, the system may be deployed for use with one or more search engines available through the Internet, or for use with a proprietary search engine local to the search system, or some combination of these. In one aspect, a user may explicitly select one or more search engines for receipt of the query, such as by selecting search engines or categories of search engines in a check box user interface. The query may be submitted to one or more search engines, with results displayed within the interface as shown in step 810.

As shown in step 812, the process 800 may provide a user with an opportunity to import a search result into the current simulation. Where this option is selected, the simulation with the new object may be rendered for the user as shown in step 814. As generally described above, this may include virtually trying on an article of clothing, adding an appliance to a simulation of a kitchen, or any other suitable import of an object into a simulation. If this option is not selected, the process 800 may return to step 802 where a description of a new object is received. This may include incremental changes to the current description or the initiation of an entirely new description.

It will be appreciated that the various steps identified and described above may be varied, and that the order of steps may be changed to suit particular applications of the techniques disclosed herein. All such variations and modifications are intended to fall within the scope of this disclosure. As such, the depiction and/or description of an order for various steps should not be understood to require a particular order of execution for those steps, unless required by a particular application, or explicitly stated or otherwise clear from the context. For example, in one embodiment a user may “try on” a search result, and this may be used to seed a new description with visual attributes from the search result. As another example, a user may fully describe an object in step 802 before simulation, and may further request initial results for display prior to initiating any simulation. All such variations are intended to fall within the scope of this disclosure.

Numerous enhancements may be provided to the systems and methods described above.

For example, the user interface for creating a query may be enhanced with a graphical input which may receive an initial product description in the form of a digital photograph, a facsimile, a sketch created by a user with online drawing tools, a CAD model or other three-dimensional model, or other graphical or image-based input. This image may be analyzed using techniques known in the art to extract visual attributes that may be employed to prepare a search, or to pre-load any number of selection criteria for the iterative description techniques disclosed above. Thus, in one embodiment, a user may take a photograph of an item, such as an article of clothing, with a device such as a cellular phone camera, and load this digital photograph into the system described above to assist the user in locating and purchasing the item or a similar item for personal use. More generally, a user may provide a graphical description, including any of the foregoing models or images, for use in initiating a simulation-assisted search.

In another aspect, social networking techniques may be employed to develop and refine descriptive vocabulary. At a high level, this approach permits evolution of descriptive terminology according to fashion trends, popular phraseology, and the like. In one aspect, as noted above, objects such as products may be tagged with metadata derived from social networking sites. This process may be slightly constrained, perhaps productively so, through the use of a Wiki or the like specifically designed for user-created metadata. A visual description Wiki may, for example, provide an interface for adding new content. In this interface, a user may add a new visual feature through a photograph, a drawing, a CAD drawing or other three-dimensional model, a fabric pattern, or the like, along with one or more visual attributes and/or values that describe the new feature. The interface may itself also provide one or more drawing tools for direct input of the visual features. The interface may permit explicit specification of a full attribute description, or may support semi-automated attribute creation such as through user-provided identification of similar or related items. In one aspect, the Wiki may monitor usage of each new feature and/or description and provide quantitative or qualitative evaluations of adoption, popularity, and the like (either for use of a new feature in products or use of a new description for an existing feature).

While the visual description interface may be available to all users, a secure interface may be provided through which authorized users can specify new products. This may include, for example, a board of editors or expert advisors in the relevant field, manufacturers, vendors, and the like. These users may directly specify terminology and visual specifications for immediate use by search engines and the like, and may provide any corresponding keywords, images, simulation models, and other related content. These users may also evaluate and edit content contributed by the general public or developed through the social networking techniques described above.

Another interface, which may be public or non-public, may receive identification of new search engines. This interface may also permit the submission of information about search syntax, content, and so forth that may be used to incorporate the new search engine into the systems and methods described above.

In another aspect, the user interface 110 described above may be enhanced with numerous features. For example, the interface may provide a closet feature—a visual metaphor for storing clothing selections similar to an electronic shopping cart where a user can retrieve and simulate items in the closet. In one aspect, this virtual closet may subscribe to syndicated data feeds of new clothing products. The data feeds may be processed so that a user can receive computer-generated notifications when clothing having the features of a closet item is published on the data feeds. Notifications may also or instead be generated when a new product has a feature set that is similar to one or more of the closet items. Using this closet metaphor, a user may specify clothes of interest according to visual attributes, and virtually shop for these items in a continuous manner by monitoring relevant data feeds.

It will be appreciated that the above systems and methods described above, and the steps and/or components thereof, may be realized in hardware, software, or any combination of these suitable for a particular application. The hardware may include a general purpose computer and/or dedicated computing device. The processes may be realized in one or more microprocessors, microcontrollers, embedded microcontrollers, programmable digital signal processors or other programmable device, along with internal and/or external memory. The processes may also, or instead, be embodied in an application specific integrated circuit, a programmable gate array, programmable array logic, or any other device that may be configured to process electronic signals. It will further be appreciated that the process(es) may be realized as computer executable code created using a structured programming language such as C, an object oriented programming language such as C++, or any other high-level or low-level programming language (including assembly languages, hardware description languages, database programming languages, and so forth) that may be stored, compiled or interpreted to run on one of the above devices, as well as heterogeneous combinations of processors, processor architectures, or combinations of different hardware and software. At the same time, processing may be distributed across a number of computers and other devices, or all of the functionality may be integrated into a dedicated, standalone product selection or configuration device. All such permutations and combinations are intended to fall within the scope of the present disclosure.

While the invention has been described in connection with certain preferred embodiments, other embodiments may be understood by those of ordinary skill in the art and are encompassed herein. As such, this disclosure is to be afforded the broadest interpretation allowable by law.

What is claimed is:

1. A method comprising:
receiving a selection of one or more visual attributes of an object;
creating a simulation of the object with the one or more visual attributes;
presenting the simulation to a user; and
generating a textual search string corresponding to the simulation.

2. The method of claim 1 further comprising presenting the textual search string to at least one search engine.

3. The method of claim 2 further comprising receiving one or more results from the at least one search engine.

4. The method of claim 3 further comprising modifying the simulation according to at least one of the one or more results.

5. The method of claim 2 wherein the at least one search engine includes an Internet retail site.

6. The method of claim 2 wherein the at least one search engine includes a product selection site.

7. The method of claim 1 further comprising presenting the textual search string to a plurality of search engines to obtain search results.

8. The method of claim 7 further comprising displaying the search results to the user.

9. The method of claim 1 further comprising generating a plurality of search strings corresponding to the simulation, each one of the search strings using a syntax adapted for one or more search engines.

10. The method of claim 1 further, comprising receiving a selection of one or more search engines and generating a textual search string for each one of the one or more search engines.

11. The method of claim 1 wherein receiving the selection of one or more visual attributes includes extracting the one or more visual attributes from a digital image.

12. The method of claim 1 wherein receiving the selection of one or more visual attributes includes extracting the one or more visual attributes from a digital sketch created by a user.

13. The method of claim 1 wherein presenting the simulation includes receiving personalization data and personalizing the simulation according to the personalization data.

14. The method of claim 13 wherein personalization data relates to one or more of height, weight, age, gender, hair color, hair style, hair length, body type, body measurements, skin tone, and head shape.

15 to 31. (canceled)

32. A computer program product comprising computer executable code embodied in a computer readable medium that, when executing on one or more computing devices, performs the steps of:
receiving a selection of one or more visual attributes of an object;
creating a simulation of the object with the one or more visual attributes;
presenting the simulation to a user; and
generating a textual search string corresponding to the simulation.

33. The computer program product of claim 32 further comprising code that performs the step of presenting the textual search string to at least one search engine.

34. The computer program product of claim 33 further comprising code that performs the step of receiving one or more results from the at least one search engine.

35. The computer program product of claim 34 further comprising code that performs the step of modifying the simulation according to at least one of the one or more results.

36. The computer program product of claim 33 wherein the at least one search engine includes an Internet retail site.

37. The computer program product of claim 33 wherein the at least one search engine includes a product selection site.

38. The computer program product of claim 32 further comprising code that performs the step of presenting the textual search string to a plurality of search engines to obtain search results.

39 to 98. (canceled)

99. A user interface comprising:
a first window that receives an incremental specification of a plurality of visual attributes for a product from a user to provide a specification for the product;
a second window that displays a simulation of the product according to the specification; and
a control for initiating a search among a plurality of remote search engines for items having the plurality of visual attributes.

100. A user interface of claim 99 further comprising a third window that displays search results from the plurality of remote search engines.

101. A user interface of claim 99 wherein the first window includes a questionnaire.

102. A user interface of claim 99 wherein the user interface includes software that translates the specification of the product into a. search string for the search.

103 to 107. (canceled)
